(19) United States
(12) Patent Application Publication
(10) Pub. No.: US 2006/0034397 A1
(43) Pub. Date: Feb. 16, 2006

(54) Method and apparatus for transmitting and receiving preamble signal in a wireless communication system

(75) Inventors: Jae-Yong Lee, Seongnam-si (KR); Ji-Ho Jang, Seoul (KR); Tae-Gon Kim, Seoul (KR); Yun-Sang Park, Suwon-si (KR); Bong-Gee Song, Seongnam-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/201,733

(22) Filed: Aug. 11, 2005

(30) Foreign Application Priority Data
Aug. 16, 2004 (KR) 10-2004-0066575

(51) Int. Cl. H04J 11/00

(52) U.S. Cl. 375/340; 370/208

(57) ABSTRACT

Disclosed is an apparatus and a method for transmitting/receiving synchronization mode information in a wireless communication system. A transmission apparatus in the wireless communication system includes a mode information creating unit for creating operation mode information based on a determined utilized bandwidth, and a preamble generating unit for outputting a frequency domain preamble signal including the created operation mode information. A reception apparatus includes a signal receiving unit for receiving a frequency domain preamble signal, a bandwidth determining unit for determining a utilized bandwidth, and a mode information detecting unit for detecting operation mode information from the frequency domain preamble signal according to the determined utilized bandwidth.

### PRIORITY

This application claims priority to an application entitled Method and Apparatus for Transmitting and Receiving Preamble Signal in a Wireless Communication System” filed in the Korean Intellectual Property Office on Aug. 16, 2004 and assigned Serial No. 2004-66575, the contents of which are incorporated herein by reference.

### BACKGROUND OF THE INVENTION

1. Field of the Invention

The present invention relates to a wireless communication system, and more particularly to an apparatus and a method for transmitting/receiving a preamble in a wireless communication system.

2. Description of the Related Art

Generally, mobile communication systems employing cellular communication methods are representative of wireless communication systems. Mobile communication systems can employ a multiple access scheme in order to communicate with a plurality of users. Typical multiple access schemes used with mobile communication systems are known as a time division multiple access (TDMA) scheme, and a code division multiple access (CDMA) scheme. As CDMA systems evolve they have transformed from systems which primarily provided voice service to systems for transmitting high-speed packet data.

However, the CDMA scheme makes it difficult to transmit a greater amount of multimedia data due to limited resources inherently available (i.e. the limited number of codes). Accordingly, a multiple access scheme is required, which can distinguish between a greater number of users and transmit a greater amount of data to the distinguished users. In order to meet such a requirement, an orthogonal frequency division multiple access (OFDMA) scheme and an orthogonal frequency division multiplexing (OFDM) scheme have been suggested as multiple access schemes. Such multiple access schemes distinguish users by using a plurality of sub-channels having orthogonality, and they transmit data to the distinguished users through the sub-channels.

Accordingly, a cellular system employing the OFDMA scheme in order to transmit high-speed data has been suggested. An IEEE 802.16d standard meeting has researched and studied the OFDMA scheme in order to provide high-speed wireless Internet services. The IEEE 802.16d standard meeting suggests OFDM system standards for a variety of operation modes. Hereinafter, the operation modes will be described.

First, sub-channelizing schemes include four schemes such as a PUSC (Partial Usage of Sub-Channel) scheme, an FUSC (Full Usage of Sub-Channel) scheme, an optional FUSC scheme, and an AMC (Adaptive Modulation and Coding) scheme.

Also, channel coding schemes include four channel coding schemes such as a CC (Convolutional Coding) scheme, a CTC (Convolutional Turbo Coding) scheme, a BTC (Block Turbo Coding) scheme, and a ZT-CC (Zero Tail Convolutional Coding) scheme.

Hereinafter, the sub-channelizing schemes will be briefly described.

(a) The PUSC (Partial Usage of Sub-channel) scheme: this scheme makes up sub-channels by using a portion of sub-carriers assigned for data in total frequency bands.

(b) The FUSC (Full Usage of Sub-Channel) scheme: this scheme makes up sub-channels by using total sub-carriers assigned for data in total frequency bands.

(c) The optional FUSC scheme: this scheme is similar to the FUSC scheme, but has an equation different from the FUSC scheme.

(d) The AMC (Adaptive Modulation and Coding) scheme: this scheme makes up sub-channels by dividing adjacent bands in total frequency bands. Hereinafter, a method for downlink data transmission using the sub-channelizing schemes will be described.

FIG. 1 illustrates an operation mode of a down link frame provided by the IEEE 802.16d standard. Hereinafter, the operation mode of the down link frame provided by the IEEE 802.16d standard will be described in detail with reference to FIG. 1.

As shown in FIG. 1, the down link frame includes a preamble and a frame control information header (FCH; Frame Control Header) following the preamble. The frame control information header includes sub-channelizing scheme information for symbols consecutively transmitted during a down link frame duration. As shown in FIG. 1, the PUSC scheme, the FUSC scheme, the optional FUSC scheme, and the AMC scheme are used as the sub-channelizing schemes.

Meanwhile, the preamble provides cell search information and initial synchronization information. The frame control information includes positions of downlink/uplink maps and sub-channelizing scheme information and channel coding information for making the maps. Accordingly, since consecutively-transmitted symbol information cannot be obtained before decoding the FCH, data cannot be decoded. Therefore, predetermined sub-channelizing and channel coding schemes are provided for the FCH, and the FCH is decoded on the basis of the rule described above. Then, downlink/uplink map information transferred after the decoding of the FCH is decoded.

Generally, when data communication is achieved, that is, the FCH transmission (initial transmission) is achieved, specific sub-channelizing and channel coding schemes are selected. That is, as described above, the standard defines that only one fixed operation mode, of various operation modes, is essentially applied to start data following the preamble in the down link. In other words, only one fixed operation mode can be used for the first several symbols sending the frame control information in the down link.

Currently, the IEEE 802.16d standard defines that the PUSC scheme, from among the above-described sub-channelizing schemes and the CC (convolutional coding) scheme, from among the channel coding schemes, are essentially used for the FCH and the downlink/uplink maps. However, these restrictions are inefficient and cause communication vendors and developers to waste valuable communication resources, to use the initial sub-channelizing scheme and the initial channel coding scheme in a specific system. However, since an initial operation mode is set to one scheme, the communication vendors and the developers have to use this fixed initial operation mode. In this case, a terminal as well as the specific system must employ the fixed initial mode. Therefore, communication resources may be wasted.

In the meantime, if an initial operation mode for the frame control information symbol is not determined or if it is difficult to determine the initial operation mode, it is difficult to decode the frame control information symbols and to determine a sub-channelizing scheme and a channel coding scheme for symbols following the frame control information symbol. Accordingly, data symbols cannot be decoded. Accordingly, a method capable of exactly detecting an operation mode without wasting resources due to the above-mentioned restrictions in development of a system is required.

### SUMMARY OF THE INVENTION

Accordingly, the present invention has been made to solve the above-mentioned problems occurring in the prior art, and an object of the present invention is to provide a method and an apparatus for transmitting and receiving synchronization mode information in a wireless communication system.

In order to accomplish the above object, according to an aspect of the present invention, there is provided a transmission apparatus in a wireless communication system which can carry operation mode information through a frequency domain preamble signal and determine the length of the operation mode information according to a utilized bandwidth.

In order to accomplish the above object, according to an aspect of the present invention, there is provided a reception apparatus in a wireless communication system which can extract operation mode information determined according to a utilized bandwidth when detecting the operation mode information from a frequency domain preamble signal.

In order to accomplish the above object, according to an aspect of the present invention, there is provided a transmitting method for determining operation mode information according to a utilized bandwidth and generating and transmitting a frequency domain preamble signal including the determined operation mode information.

In order to accomplish the above object, according to an aspect of the present invention, there is provided a receiving method for detecting corresponding operation mode information from a received frequency domain preamble signal according to a utilized bandwidth.

### BRIEF DESCRIPTION OF THE DRAWINGS

The above and other objects, features and advantages of the present invention will be more apparent from the following detailed description taken in conjunction with the accompanying drawings, in which:

FIG. 1 illustrates an operation mode of a downstream link frame provided by the IEEE 802.16d standard;

FIG. 2 illustrates an operation mode of a downstream link frame in an IEEE 802.16d system according to one embodiment of the present invention;

FIGS. 3A to 3C illustrate a structure of a preamble signal in a frequency domain according to one embodiment of the present invention;

FIG. 4 is a flowchart showing a control procedure of a preamble transmitting method in a wireless communication system according to one embodiment of the present invention;

FIG. 5 is a block diagram showing a structure of a transmission apparatus according to one embodiment of the present invention;

FIG. 6 is a flowchart showing a control procedure of a preamble receiving method in a wireless communication system according to one embodiment of the present invention;

FIG. 7 is a block diagram showing a structure of a transmission apparatus according to one embodiment of the present invention; and

FIG. 8 is a block diagram showing a structure of a transmission apparatus according to another embodiment of the present invention.

### DETAILED DESCRIPTION OF THE PREFERRED EMBODIMENT

Hereinafter, preferred embodiments of the present invention will be described in detail with reference to the accompanying drawings. Note that the same or similar components in drawings are designated by the same reference numerals as far as possible although they are shown in different drawings. In the following description of the present invention, a detailed description of known functions and configurations incorporated herein will be omitted when it may make the subject matter of the present invention unclear.

According to one embodiment of the present invention, a wireless communication system can be constructed in such a manner that an initial operation mode is not fixed, but rather is one of several optional operation modes and is carried by each of first preambles of all downlink frames. That is, according to one embodiment of the present invention, a preamble transmitting side can insert initial operation mode information into a preamble, and a preamble receiving side can detect the initial operation mode by using the preamble. To end this, according to the present invention, portions of preamble codes of a preamble signal provided by the standard can be used as operation mode indicators (OMIs). In this case, positions of the operation mode indicators can be determined by a protocol which is shared by both a transmission apparatus and a reception apparatus.

Herein, according to one embodiment of the present invention, frequency resources are efficiently used by adjusting the length of operation mode information according to operation frequencies. In detail, according to one embodiment of the present invention, there are provided a transmission apparatus, a reception apparatus, and a method for determining variables such as the length of operation mode data, an operation mode inserting position, and a preamble signal pattern depending on utilized bands when a preamble for reporting operation mode employed in a 802.16 standard is transmitted. Frequency bands employed by the 802.16 standard includes 20 MHz (2048 FFT (Fast Fourier Transform), 10 MHz (1024 FFT), 5 MHz (512 FFT), and 1.25 MHz (128 FFT). According to one embodiment of the present invention, there are provided a transmission apparatus, a reception apparatus, and a method in an orthogonal frequency division multiplexing (OFDM) communication system for determining the length of operation mode information in a preamble, and creating and detecting the operation mode information according to utilized bandwidths.

According to one embodiment of the present invention, since operation mode information is varied depending on utilized bandwidths, a preamble including the optimum operation mode information can be created in each bandwidth. In consideration of the optimum performance of the transmission apparatus and a reception apparatus, it is possible to generate a preamble having the same operation mode information or different operation mode information in mutually exclusive bandwidths.

To realize the present invention, a protocol for operation bandwidths is required between the transmission apparatus and the reception apparatus such that the transmission apparatus (system) and the reception apparatus (e.g., a user's terminal) process signals in accordance with each other.

Herein, the operation bandwidths are selected through search of the reception apparatus or according to an indication of the system. According to one embodiment of the present invention, there are provided a transmission method and a reception method for determining utilized bandwidths and adjusting the length of operation mode information according to the utilized bandwidths at the time point at which the utilized bandwidths are determined. Accordingly, the present invention can be applied to a system which sends a system operation mode for simultaneously serving several bandwidths.

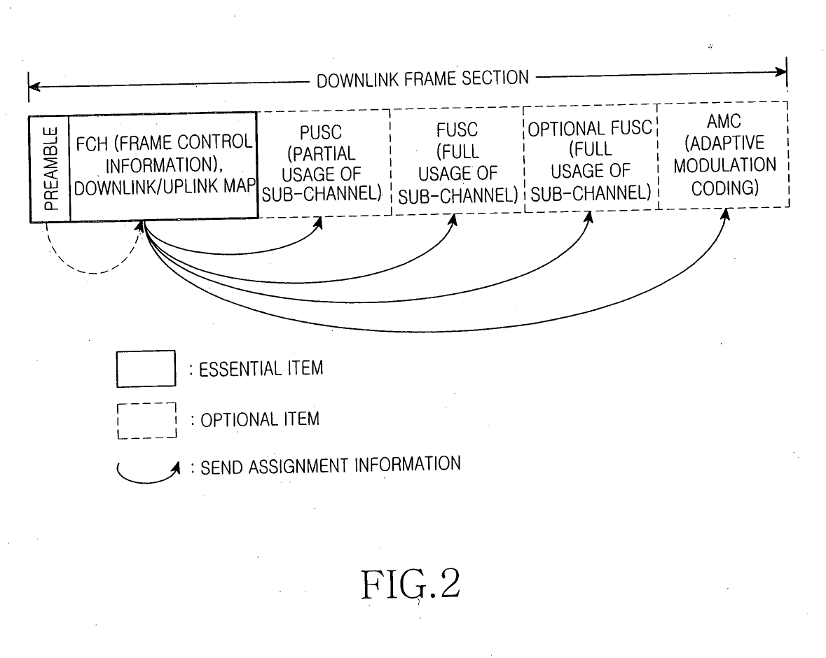

FIG. 2 illustrates an operation mode of a downstream link frame in an IEEE 802.16d system according to one embodiment of the present invention.

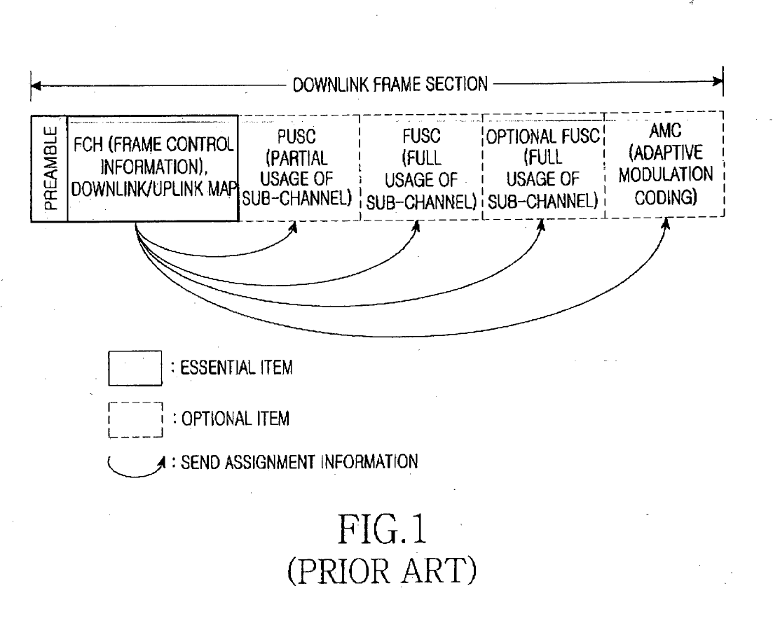

In comparison with FIG. 1, FIG. 2, illustrates a method for setting an initial operation mode according to one embodiment of the present invention and is different from the conventional technique (i.e., the IEEE 802.16d standard). As shown in FIG. 2, a sub-channelizing scheme and a coding scheme of the FCH can be indicated by using a preamble. In detail, the preamble indicates that only a sub-channelizing scheme is changed, that only a coding scheme is changed, or that both a sub-channelizing scheme and a coding scheme are changed through various methods described below. In contrast to the conventional technique, the present invention does not only employ the PUSC scheme as the sub-channelizing scheme, but can change the sub-channelizing scheme depending on preamble patterns. Also, the present invention may change only a sub-channelizing scheme, only a coding scheme, or both of the sub-channelizing scheme and the coding scheme according to methods of mapping a preamble.

According to one embodiment of the present invention, since the sub-channelizing scheme and the channel coding scheme used for the FCH and the downlink/uplink maps are sent by means of a preamble regularly transmitted through every down link frame, it is unnecessary to follow an essential condition (as defined in the 802.16d standard) that an initial operation mode is fixed. Accordingly, an initial operation mode is sent through a preamble, and the FCH and the downlink/uplink maps are decoded by using the initial operation mode detected from the preamble. Also, since a sub-channelizing scheme and a channel coding scheme for an OFDM symbol following the FCH and the downlink/uplink maps are sent through the FCH and the downlink/uplink maps, data can be decoded by using the sub-channelizing scheme and the channel coding scheme.

According to one embodiment of the present invention, when a preamble for reporting an operation mode provided in the IEEE 802.16 standard is transmitted, the length of operation mode information is varied depending on utilized bands. Frequency bands employed by the IEEE 802.16 standard includes 20 MHz (2048 FFT), 10 MHz (1024 FFT), 5 MHz (512 FFT), and 1.25 MHz (128 FFT). According to one embodiment of the present invention, an OFDM communication system assigns and detects the different lengths of operation mode distinguishing information according to utilized bandwidths.

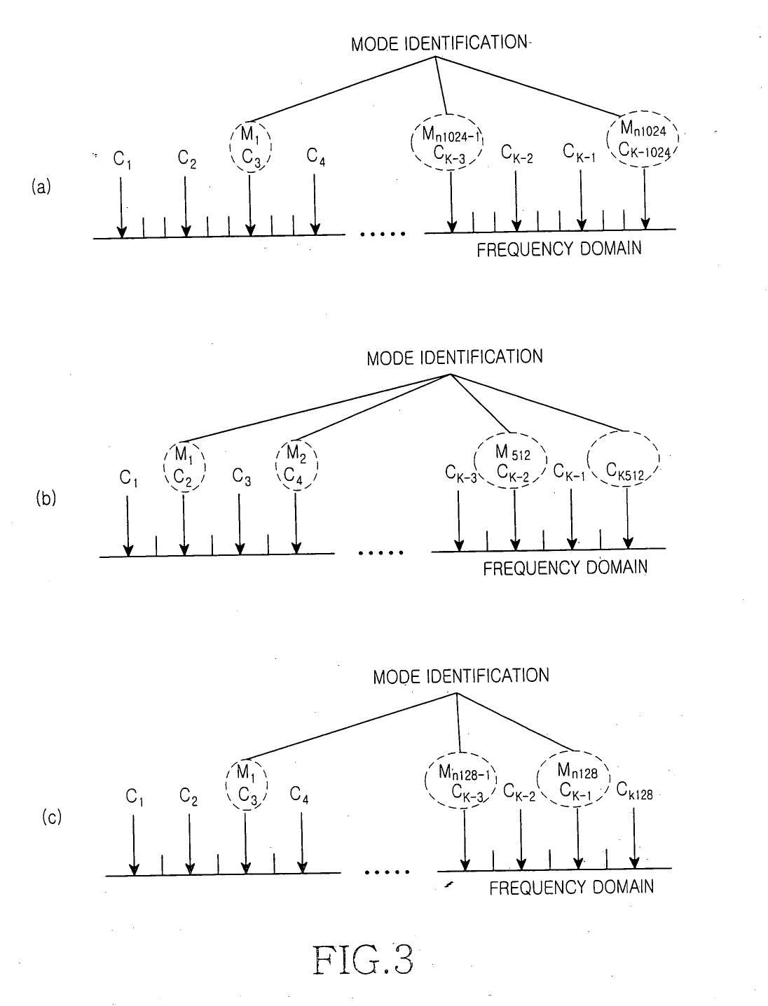

FIGS. 3A to 3C illustrate structures of preamble signals in a frequency domain according to one embodiment of the present invention. FIG. 3A illustrates a structure of a preamble signal having a utilized frequency band of 100 MHz (1024 FFT), FIG. 3B illustrates a structure of a preamble signal having a utilized frequency band of 5 MHz (512 FFT), and FIG. 3C illustrates a structure of a preamble signal having a utilized frequency band of 1.25 MHz (128 FFT). Although FIGS. 3A to 3C illustrate that the number of frequency intervals of the preamble signals is 3, the number of the frequency interval may be 2, etc., as desired.

As shown in FIGS. 3A to 3C, according to one embodiment of the present invention, operation mode indicators are transmitted by using portions of preamble codes of a frequency domain preamble signal. Herein, as described above, according to one embodiment of the present invention, mode information can be variably assigned depending on utilized frequency bands.

An IEEE 802.16e standard suggests utilized frequency bands of 1024 FFT, 512 FFT, 128 FFT, etc. According to one embodiment of the present invention, the ratio of the number of preamble codes to the number of operation mode codes can be uniformly maintained in overall frequency bands of a preamble signal by differently setting the number of an operation mode to N1024, N512, and N218 according to operation bandwidths (where N is a positive integer).

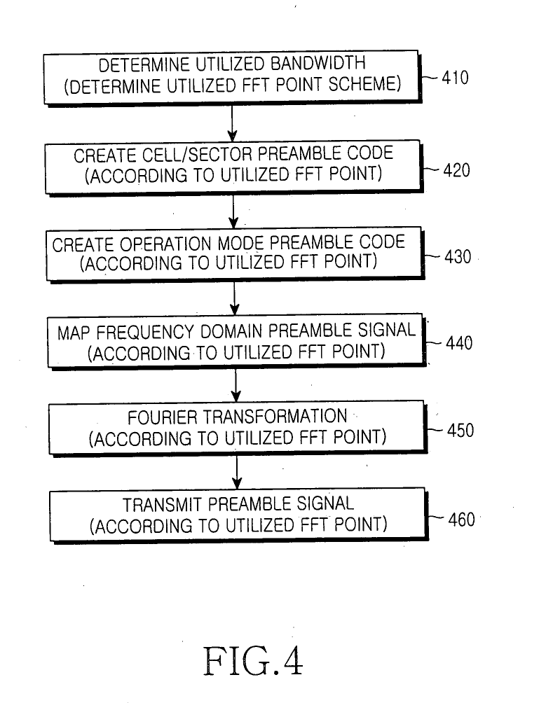

FIG. 4 is a flowchart showing a control procedure of a preamble transmission method in a wireless communication system according to one embodiment of the present invention. A transmission apparatus determines a utilized bandwidth in step 410. The utilized bandwidth determining procedure is used to determine a utilized FFT point scheme. Frequency bands employed by the IEEE 802.16 standard include 20 MHz (2048 FFT), 10 MHz (1024 FFT), 5 MHz (512 FFT), and 1.25 MHz (128 FFT). According to one embodiment of the present invention, the OFDM communication system assigns the length of operation mode distinguishing information according to utilized bandwidths.

Subsequently, in step 420, the transmission apparatus creates cell/sector preamble codes according to determined utilized bandwidths, i.e., utilized FFT points. Herein, a cell/sector distinguishing code may be a preamble code of a preamble signal in a frequency domain, which is provided in the conventional standard. Then, in step 430 the transmission apparatus determines and creates operation mode preamble codes (e.g., mode codes) according to determined utilized bandwidths, i.e., the utilized FFT points After that, the transmission apparatus maps the cell/sector preamble codes and the operation mode preamble codes to preamble signals in the frequency domain according to the utilized FFT points in step 440. The transmission apparatus Fourier-transforms a corresponding preamble signal in the frequency domain into a time-domain preamble signal in step 450, and then, transmits the preamble signal to a reception apparatus in the time domain in step 460.

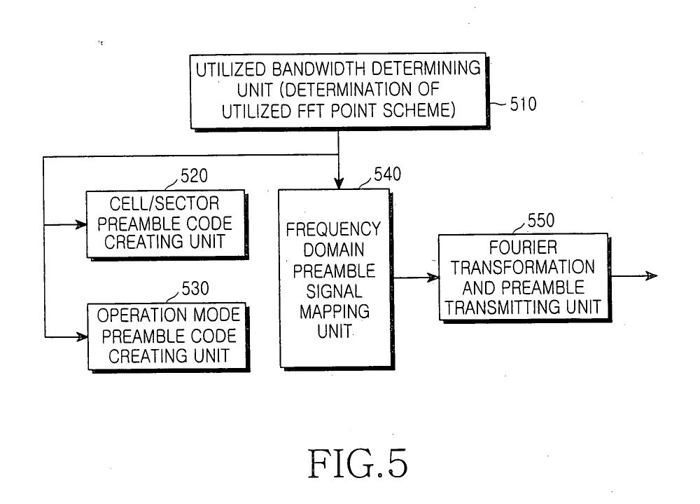

FIG. 5 is a block diagram showing a structure of the transmission apparatus according to one embodiment of the present invention.

The transmission apparatus includes a utilized bandwidth determining unit 510, a cell/sector preamble code creating unit 520, an operation mode preamble code creating unit 530, a frequency domain preamble signal mapping unit 540, and a Fourier transformation and preamble transmitting unit 550.

The utilized bandwidth determining unit 510 determines autilized bandwidth from among a plurality of available bandwidths according to a predetermined condition. Herein, the utilized bandwidth determining unit 510 can actively determine a suitable bandwidth or can determine a suitable bandwidth under a predetermined control. The utilized bandwidth determining unit 510 provides information about the determined utilized bandwidth to the cell/sector preamble code creating unit 520, the operation mode preamble code creating unit 530, and the frequency domain preamble signal mapping unit 540.

The cell/sector preamble code creating unit 520 creates a cell/sector distinguishing code according to the determined utilized bandwidth, i.e., the utilized FFT points. The cell distinguishing code may be a preamble code of a preamble signal in the frequency domain which is formed according to the conventional standard. The operation mode preamble code creating unit 530 creates an operation mode code according to the determined utilized bandwidth, i.e., the utilized FFT points. Herein, the operation mode code may be an operation mode indicator for distinguishing an operation mode.

The frequency domain preamble signal mapping unit 540 maps the cell/sector distinguishing code and the operation mode code to sub-carriers for the preamble signal according to the utilized FFT points. The transmission apparatus and the reception apparatus can determine operation mode code positions and a utilized bandwidth by a predefined protocol between the transmission apparatus and the reception apparatus and can transmit/receive specific control information. Also, the frequency domain preamble signal mapping unit 540 outputs a generated frequency domain preamble signal to the Fourier transformation and preamble transmitting unit 550. The Fourier transformation and preamble transmitting unit 550 Fourier transforms the frequency domain preamble signal received from the frequency domain preamble signal mapping unit 540, and then, transmits the frequency domain preamble signal to the reception apparatus.

Hereinafter, an apparatus and a method for receiving a transmitted preamble signal will be described.

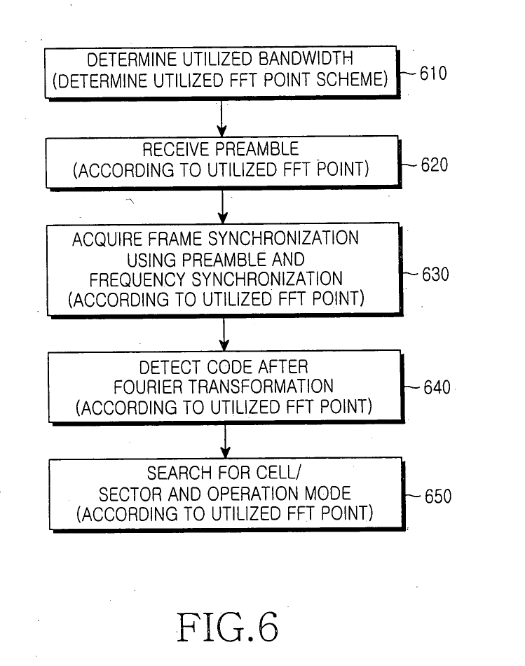

FIG. 6 is a flowchart showing a control procedure of a preamble signal receiving method in a wireless communication system according to one embodiment of the present invention.

The reception apparatus determines a utilized bandwidth, i.e., a utilized FFT point scheme in step 610. The utilized bandwidth, i.e., the utilized FFT point scheme can be determined through a predefined protocol that is shared between the transmission apparatus and the reception apparatus or according to control information transmitted through another route. After that, the reception apparatus receives a time domain preamble signal in step 620. Herein, steps 610 and 620 may be randomly processed, and their order may be changed.

If the reception apparatus determines control information according to the utilized bandwidth, the reception apparatus performs step 630 by using the control information so as to obtain a frame synchronization and a frequency synchronization from the time domain preamble signal. After that, the reception apparatus Fourier transforms the time domain preamble signal into a frequency domain preamble signal in step 640. The frequency domain preamble signal includes preamble codes for distinguishing cell/sectors and for distinguishing operation modes. In step 650, the reception apparatus completes its detection and determination of a cell/sector and an operation mode on the basis of the control information according to the utilized bandwidth.

Hereinafter, description about a structure and an operation of the reception apparatus will given.

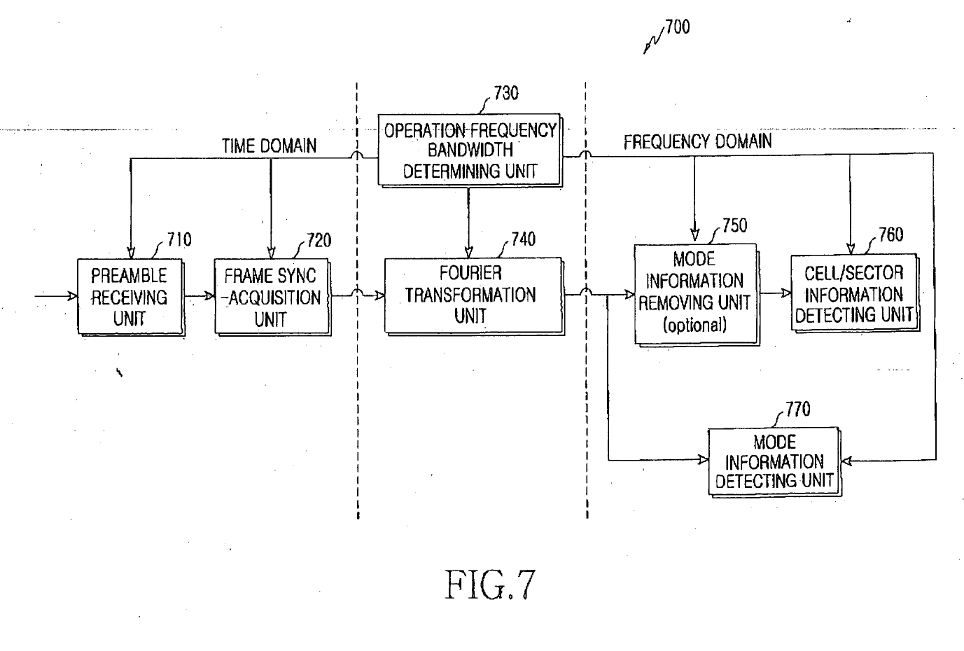

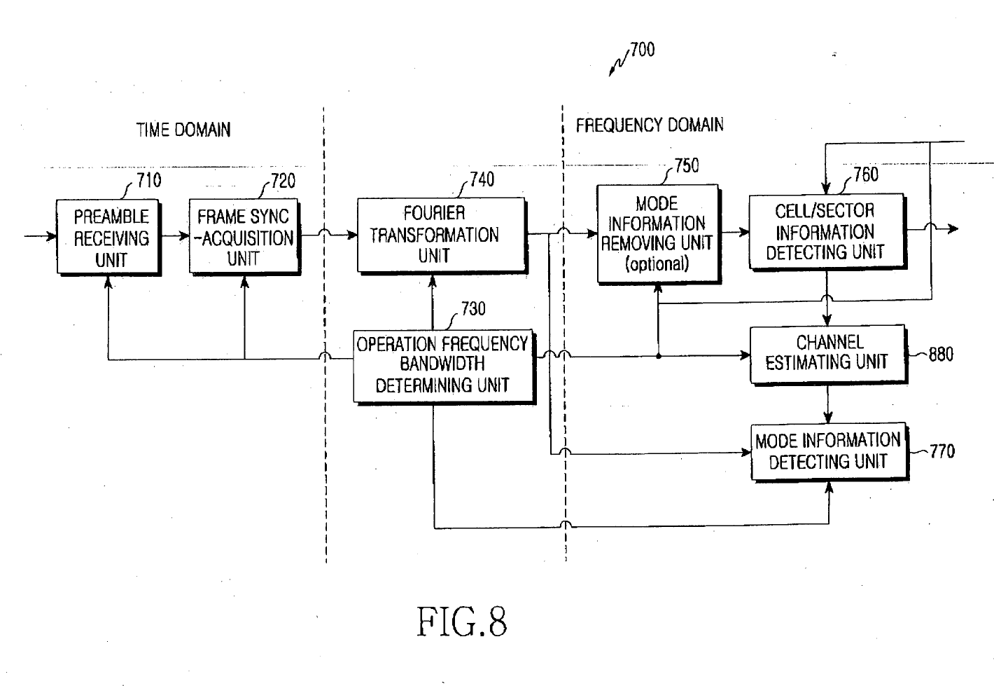

FIG. 7 is a block diagram showing a structure of a reception apparatus 700 according to one embodiment of the present invention, and FIG. 8 is a block diagram showing a structure of the reception apparatus 800 according to another embodiment of the present invention.

The reception apparatus 700 includes a preamble receiving unit 710 for receiving a preamble signal, a frame sync-acquisition unit 720, an operation frequency bandwidth determining unit 730, a Fourier transformation unit 740, an optional mode information removing unit 750, a cell/sector information detecting unit 760, a mode information detecting unit 770, and a channel estimating unit 880.

First, the operation frequency bandwidth determining unit 730 determines a utilized bandwidth, i.e., a utilized FFT point. The utilized bandwidth, i.e., the utilized FFT point scheme can be determined through a protocol between the transmission apparatus and the reception apparatus or according to control information transmitted through another route.

The operation frequency bandwidth determining unit 730 provides information about the utilized bandwidth, i.e., an operation frequency band to the preamble receiving unit 710 for receiving a preamble signal, the frame sync-acquisition unit 720, the Fourier transformation unit 740, the mode information removing unit 750, the cell/sector information detecting unit 760, and the mode information detecting unit 770, and the channel estimating unit 880 and allows each of these units to operate accordingly with respect to the determined operation frequency band. The operation frequency bandwidth determining unit 730 initially receives data by using prior knowledge of the mode code location.

The preamble receiving unit 710 receives a preamble signal transmitted from the transmission apparatus and provides the preamble signal to the frame sync-acquisition unit 720. The frame sync-acquisition unit 720 acquires an initial synchronization from the preamble signal, and then, provides the preamble signal to the Fourier transformation unit 740. The Fourier transformation unit 740, Fourier transforms a time domain preamble signal into a frequency domain preamble signal and provides the frequency domain preamble signal to the mode information removing unit 750 and the mode information detecting unit 770. The mode information removing unit 750 removes the operation mode information by padding mode information carrying parts of the frequency domain preamble signal with 0s or by inserting 0s into the mode information carrying parts of the frequency domain preamble signal. Also, the mode information removing unit 750 outputs a frequency domain preamble signal without the mode information to the cell/sector information detecting unit 760.

The cell/sector information detecting unit 760 detects a preamble code of a preamble provided for every cell and every sector and searches for a cell and a sector. At this time, the mode information carrying parts do not exert influence on the search for the cell/sector. According to one embodiment of the present invention, the OFDM communication system creates and assigns (and likewise detects) the length of operation mode information of a preamble, proportionally to utilized bandwidths. That is, the size of the operation mode is determined in proportion to the size of the utilized bandwidth. In detail, frequency bands suggested by the IEEE 802.16 standard includes 20 Mhz (2048 FFT), 10 Mhz (1024 FFT), 5 Mhz (512 FFT), and 1.25 Mhz (128 FFT). According to one embodiment of the present invention, the frequency band of 20 Mhz corresponding to a 2048 FFT causes the assignment of N2048 operation modes, the frequency band of 10 Mhz corresponding to 1024 FFT causes the assignment of N1024 operation modes, the frequency band of 5 Mhz corresponding to 512 FFT causes the assignment of N512 operation modes, and the frequency band of 1.25 Mhz corresponding to 128 FFT causes the assignment of N128 operation modes.

Also, the mode information detecting unit 770 decodes operation mode information carried by a sub-carrier by using previously known mode information and can determine an operation mode according to the decoded operation mode information. Herein, the mode information detecting unit 770 may previously know a position of a sub-carrier carrying the operation mode information or may receive control information relating to the operation mode information from an external unit.

The reception apparatus shown in FIG. 7 detects operation mode information using a non-coherent scheme. Alternatively, the reception apparatus shown in FIG. 8, to be described below is made up in such that it detects operation mode information using a coherent scheme.

FIG. 8 is a block diagram showing a structure of the reception apparatus 800 in a wireless communication system according to another embodiment of the present invention. The reception apparatus 800 includes a preamble receiving unit 710 for receiving a preamble signal, a frame sync-acquisition unit 720, an operation frequency band determining unit 730, a Fourier transformation unit 740, an optional mode information removing unit 750, a cell/sector information detecting unit 760, a channel estimating unit 880, and a mode information detecting unit 770. The reception apparatus 800 adds the channel estimating unit 880 to the reception apparatus 700 shown in FIG. 7. As the operation of similarly numbered elements of the reception apparatus are, unless indicated otherwise, the same as those described elsewhere (e.g., in FIG. 7), further description of their operation will not be made.

Referring to FIG. 8, the reception apparatus 800 uses a cell/sector code detection result in order to detect an operation mode. The channel estimating unit 880 finds a channel state from the cell/sector code detection result and sends the channel state information to the mode information detecting unit 770. A channel estimation result obtained from the cell/sector information detector 770 is sent as an input of the mode information detecting unit 770. Although additional circuitry may be required when the reception apparatus is constructed up as described above, a possibility for detecting mode information can increase.

As described above, according to the present invention, since an initial operation mode of an OFDM system is sent through a preamble, it is unnecessary to follow an essential condition defined in the IEEE 802.16d standard that PUSC (partial usage sub-carriers) is set as an initial operation mode. Accordingly, an initial operation mode can be variably employed according to requirements of communication vendors and developers. As described above, since the initial operation mode is flexibly used, it is possible to reduce resource waste and inefficiency resulting from the operation mode and more efficiently manage a system.

As described above, according to the present invention, since an initial operation mode of a system is not fixed, but information indicating an initial operation mode is transmitted through a preamble, it is possible to flexibly use operation modes. Also, according to one embodiment of the present invention, it is possible to realize an apparatus and a method for transmitting/receiving operation mode information which is varied depending upon utilized frequency bands. Embodiments according to the present invention may be applied to a system and a terminal capable of transmitting/receiving a plurality of utilized frequency bands.

While the invention has been shown and described with reference to certain preferred embodiments thereof, it will be understood by those skilled in the art that various changes in form and details may be made therein without departing from the spirit and scope of the invention. Consequently, the scope of the invention should not be limited to the preferred embodiments, but should be defined by the appended claims and equivalents thereof.

What is claimed is:

1. A transmission apparatus in a wireless communication system, the transmission apparatus comprising:
a mode information creating unit for creating operation mode information based on a determined utilized bandwidth; and
a preamble generating unit for outputting a frequency domain preamble signal including the created operation mode information.

2. The transmission apparatus as claimed in claim 1, further comprising a cell/sector information creating unit for creating cell/sector distinguishing information based on the determined utilized bandwidth.

3. The transmission apparatus as claimed in claim 1, wherein determination of the utilized bandwidth includes determination of a utilized FFT (Fast Fourier Transform) point scheme.

4. The transmission apparatus as claimed in claim 2, wherein the operation mode information creating unit variably determines a length of a mode according to the determined utilized bandwidth.

5. The transmission apparatus as claimed in claim 1, wherein the preamble generating unit variably assigns operation mode information to the frequency domain preamble signal according to the determined utilized bandwidth.

6. The transmission apparatus as claimed in claim 1, further comprising a utilized bandwidth determining unit for determining the utilized bandwidth.

7. A method for transmitting a preamble signal in a wireless communication system, the method comprising the steps of:
creating operation mode information based on a determined utilized bandwidth; and
outputting a frequency domain preamble signal including the created operation mode information.

8. The method as claimed in claim 7, further comprising the step of creating cell/sector distinguishing information according to the determined utilized bandwidth.

9. The method as claimed in claim 7, further comprising a step of determining a utilized bandwidth, which includes a step of determining a utilized FFT point scheme.

10. The method as claimed in claim 7, wherein a length of an operation mode information is variably set according to the determined utilized bandwidth.

11. The method as claimed in claim 7, further comprising the step of variably assigning operation mode information to the frequency domain preamble signal according to the determined utilized bandwidth.

12. A reception apparatus in a wireless communication system, the reception apparatus comprising:
a signal receiving unit for receiving a frequency domain preamble signal;
a bandwidth determining unit for determining a utilized bandwidth; and
a mode information detecting unit for detecting operation mode information from the frequency domain preamble signal according to the determined utilized bandwidth.

13. The reception apparatus as claimed in claim 12, further comprising a mode information removing unit, wherein the mode information removing unit removes operation mode information by padding a part, which carries mode information in the frequency domain preamble signal, with random information according to the determined utilized bandwidth.

14. The reception apparatus as claimed in claim 12, further comprising a cell/sector information detecting unit, wherein the cell/sector information detecting unit detects cell/sector information from sub-carriers of the frequency domain preamble signal, excluding sub-carriers carrying operation mode information, according to the determined bandwidth.

15. The reception apparatus as claimed in claim 14, further comprising a channel estimating unit, wherein the channel estimating unit finds a channel state based on the cell/sector information detection result outputted from the cell/sector information detecting unit and provides channel information obtained from the channel state to the mode information detecting unit.

16. A method for receiving a preamble signal in a wireless communication system, the method comprising the steps of:
receiving a frequency domain preamble signal;
determining a utilized bandwidth; and
detecting operation mode information from the frequency domain preamble signal based on the utilized bandwidth.

17. The method as claimed in claim 16, further comprising the step of removing operation mode information by padding a part, which carries mode information in the frequency domain preamble signal, with random information according to the determined utilized bandwidth.

18. The method as claimed in claim 16, further comprising the step of detecting cell/sector information from sub-carriers of the frequency domain preamble signal, excluding sub-carriers carrying operation mode information, according to the determined bandwidth.

19. The method as claimed in claim 18, further comprising the step of finding a channel state from the cell/sector code detection result and using channel information obtained from the channel state in order to detect the operation mode.
